(19) United States
(12) Patent Application Publication
(10) Pub. No.: US 2009/0222550 A1
(43) Pub. Date: Sep. 3, 2009

(54) MEASUREMENT OF THE EFFECTIVENESS OF ADVERTISEMENT DISPLAYED ON WEB PAGES

(75) Inventors: R. Preston McAfee, San Marino, CA (US); Michael Schwarz, Berkeley, CA (US)

Correspondence Address: YAHOO! INC.;c/o DUANE MORRIS LLP, Attn.: IP Docketing, 1 Market Plaza - 2000 Spear Tower, San Francisco, CA, 94105-1104, US

(73) Assignee: Yahoo! Inc., Sunnyvale, CA (US)

(21) Appl. No.: 12/039,564

(22) Filed: Feb. 28, 2008

(51) Int. Cl. G06F 15/16

(52) U.S. Cl. 709/224

(57) ABSTRACT

A method to determine user attentiveness to an information item included in a web page comprising: displaying an image representing a first web page that includes a first information item to a first individuals; determining a baseline time that represents a typical amount of time that respective first individuals look at the first information item; sending a first web page over a network to first user devices; and sending a second web page over a network to second user devices; wherein the second web page appears substantially the same as the first web page except with a second information item instead of the first information item; obtaining first time measurements of an amount of time that first users of the first user devices typically spend looking at the first web page; obtaining second time measurements of an amount of time that respective second users of the second user devices typically spend looking at the second web page; determining a comparative time measure that is indicative of a difference in time respective first and second users typically spend looking at the first and second web pages; using the baseline time and the comparative time measure to determine an amount of time that a typical user is likely to spend looking at the second information item included in the second web page.

### BACKGROUND OF THE INVENTION

1. Field of the Invention

The invention relates in general to advertisements delivered over the World Wide Web (WWW), and more particularly, to evaluating the effectiveness of ads delivered over the WWW.

2. Description of the Related Art

The Worldwide Web (the “Web”) provides access to a distributed database of records via the Internet. The Web uses a client-server model in which servers referred to as a Web servers, serve database records to client devices. Information extracted dynamically over the from the distributed database is displayed to users in the form of web pages. The database records are stored in the form of electronic documents known as “web pages”. In this manner, the Web provides access to a vast database of information dispersed across an enormous number of individual computer systems. Computers connected to the Internet may search for and retrieve Web pages via a computer program known as a browser, which has a powerful, simple-to-learn graphical user interface. One technique supported by a Web browser is known as hyperlinking, which permits Web page authors to create links to other Web pages which users then can retrieve by using simple point-and-click commands on the Web browser. Web pages may be constructed in any of a variety of formatting conventions, such as Hyper Text Markup Language (HTML), and may include multimedia information content such as graphics, audio, and moving pictures.

A user typically employs a search engine to navigate the Web. A search engine provides an index structure that is routinely updated to facilitate search of perhaps, billions of Web pages. A user directs a client device to request a search engine server to search for Web pages on the Internet that meet search criteria set forth in a user's search query. A typical search engine employs automated search technology that relies in large part on complex, mathematics-based database search algorithms that can select and rank Web pages based on multiple criteria such as keyword density and keyword location. A search engine server responds to a search query by delivering a response that includes one or more hyperlinks to one or more Web pages that satisfy the search request.

Advertising has become a part of the economic underpinning of the Web. A large part of the Web advertising market consists of contextual advertising, which involves placing commercial ads onto Web pages. Today, almost all of the for-profit non-transactional Web sites rely at least to some extent on contextual advertising revenue. Contextual ads typically are associated with network location identifiers, typically URLs that are associated with ad sponsors who may have some prior agreement with a Web page provider or with a search engine provider to display their ads in association with one or more selected Web pages.

While advertisement placement using contextual advertisements generally has been successful, there have been shortcomings with its use. In particular, there has been a need for an improvement in the measure of ad effectiveness. Ad effectiveness is important to ad pricing. One pricing model for contextual ads calls for advertisers pay a certain amount for every ‘click’ on the advertisement (pay-per-click or PPC). There are also other models, such as pay-per-impression, where the advertiser pays for the number of exposures of an ad, and pay-per-action, where the advertiser pays only if the ad leads to a sale or similar completed transaction. Often, an auction process determines the amount paid by an advertiser for ad placement.

Unfortunately, these various techniques to measure ad effectiveness do not directly measure user attentiveness to ads. A count of the number of ad impressions indicates how many times an ad was shown, but it does not measure user attentiveness to the ad. The number of clicks on an ad or user actions in response to an ad provide measures of how many users were motivated to respond to an ad but do not measure a typical user's attentiveness to the ad.

Thus, there has been a need for improvements in measurement of user attentiveness to advertisements presented on a web page. An improved ad effectiveness measure can lead to improved ad pricing and to also optimize ad campaigns by designing ads that do a better job at catching user attention. The present invention meets this need.

### SUMMARY OF THE INVENTION

A method is provided to measure user attentiveness to information items such as advertisements on a web page. A baseline measure of user attentiveness to a reference information item on a web page is obtained. A first web page containing the reference item is sent over a network to first users of first devices. A second web page containing a designated item is sent over the network to second users of second devices. Time spent by first users observing the first web page is compared with time spent by second users observing the second web page. The time comparison in conjunction with the baseline time is used to determine the time likely spent by the second users observing the second information item.

More specifically, in some embodiments, a method is provided to determine user attentiveness to an information item included in a web page. A baseline time represents a typical amount of time that individuals look at a first information item included in a first web page image. The first web page including the first item is sent over a network to a plurality of first user devices. A second web page including a second item is sent over the network to a plurality of second user devices. In some embodiments, the second web page appears substantially the same as the first web page except that the second web page includes a second information item instead of the first information item. First time measurements are obtained that are indicative of an amount of time that respective first users of the first user devices typically spend looking at the first web page. Second time measurements are obtained that are indicative of an amount of time that respective second users of the second user devices typically spend looking at the second web page. The respective first and second time measurements are used to determine a comparative time measure that is indicative of a difference in amounts of time respective first and second users typically spend looking at the respective first and second web pages. The baseline time and the comparative time measure are used to determine an amount of time that a typical user is likely to spend looking at the second information item included in the second web page.

These and other features and advantages of the present invention will be appreciated from the following detailed description of embodiments thereof in conjunction with the appended drawings.

### BRIEF DESCRIPTION OF THE DRAWINGS

FIG. 1 is an illustrative drawing of a screen display showing an image of a first web page that includes a reference information item in accordance with some embodiments of the invention.

FIG. 2 is an illustrative drawing of a screen display showing an image of a second web page that includes a designated information item in accordance with some embodiments of the invention.

FIG. 3 is an illustrative drawing showing a system architecture that includes a web server, a data collection server, second user devices and third user devices that are coupled to communicate over a network such as the Internet in accordance with some embodiments of the invention.

FIG. 4 is an illustrative flow chart of a first computer program controlled process used to develop a comparative time measure that is indicative of the difference in the amount of time users spend viewing the first and second web pages in accordance with some embodiments of the invention.

FIG. 5 is an illustrative flow chart of an alternative second computer program controlled process to develop a comparative time measure that is indicative of differences in the amount of time users typically spend viewing the first and second web pages and that accounts for time when the web pages are displayed but possibly not the main focus of user attention in accordance with some embodiments of the invention.

FIG. 6 is an illustrative drawing of a multi-screen web page that includes a subject information item that may be a reference item or a designated item in accordance with some embodiments of the invention.

### DETAILED DESCRIPTION OF THE PREFERRED EMBODIMENTS

The following description is presented to enable any person skilled in the art to make and use a computer implemented system and method to ascertain an estimate of the typical amount of time that users of computer devices are attentive to an information item such as an advertisement displayed on a web page, and is provided in the context of particular applications and their requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and processes are shown in block diagram form in order not to obscure the description of the invention with unnecessary detail. Thus, the present invention is not intended to be limited to the embodiments shown, but is to be accorded the widest scope consistent with the principles and features disclosed herein.

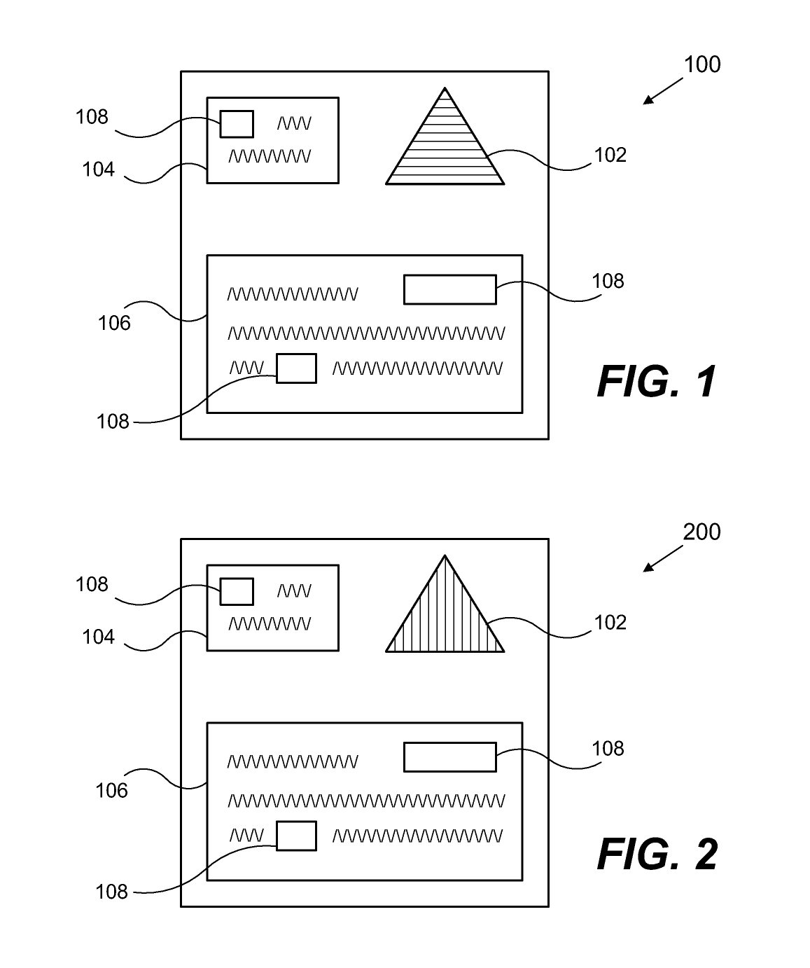

FIG. 1 is an illustrative drawing of a screen display showing an image of a first web page 100 that includes a reference information item 102. The illustrative first web page 100 also includes first and second regions 104, 106 that may include text or images or other information modes. This example web page also includes links 108 to other web pages (not shown). The reference information item 102 also may comprise a link (not shown).

The first web page 100 with the reference information item 102 is used to obtain a baseline time is obtained that is indicative of the amount of time spent by individuals looking at a reference information item 102 on the first web page 100. The reference information item 102 may be an advertisement, announcement or other web content. Specifically, a first plurality of individuals view an image of the first web page 100 with the reference item 102. A sufficient number of individuals are included in the first plurality to provide a reliable measure of the amount of time that a typical person viewing the first web page 100 actually spends viewing the portion of the web page containing the reference item 102. In some embodiments, eye tracking is used to determine the amount of time that individuals from the first plurality typically spend looking at the reference information item 102. That typical amount of time serves as a baseline time for the first web page 100 with the reference item 102. The baseline time is the time a person from the first plurality typically looks at the information item 102. In some embodiments, the baseline time is determined as an average, median or other measure of central tendency.

An eye tracking system may include a sensor (not shown) mounted to sense the individual's eye movements to ascertain when the person's eyes are looking at the reference item 102. Eye tracking systems are well known to persons of ordinary skill in the art. The particular eye tracking technique is a matter of design choice and forms no part of the present invention, and therefore, is not described herein.

FIG. 2 is an illustrative drawing of a screen display showing an image of a second web page 200 that includes a designated information item 202. The illustrative second web page 200 includes the same first and second regions 104, 106 and the same links 108 that are included in the first web page 100. The designated information item 202 also may include a link (not shown) to another web page. The designated information item 202 may be an advertisement, announcement or other web content. The first and second information regions 104, 106 and the links 108 have substantially the same relative positions on the first and second web pages 100, 200. The reference information item 102 and the designated information item 202 also have substantially the same relative positions on the first and second web pages 100, 200.

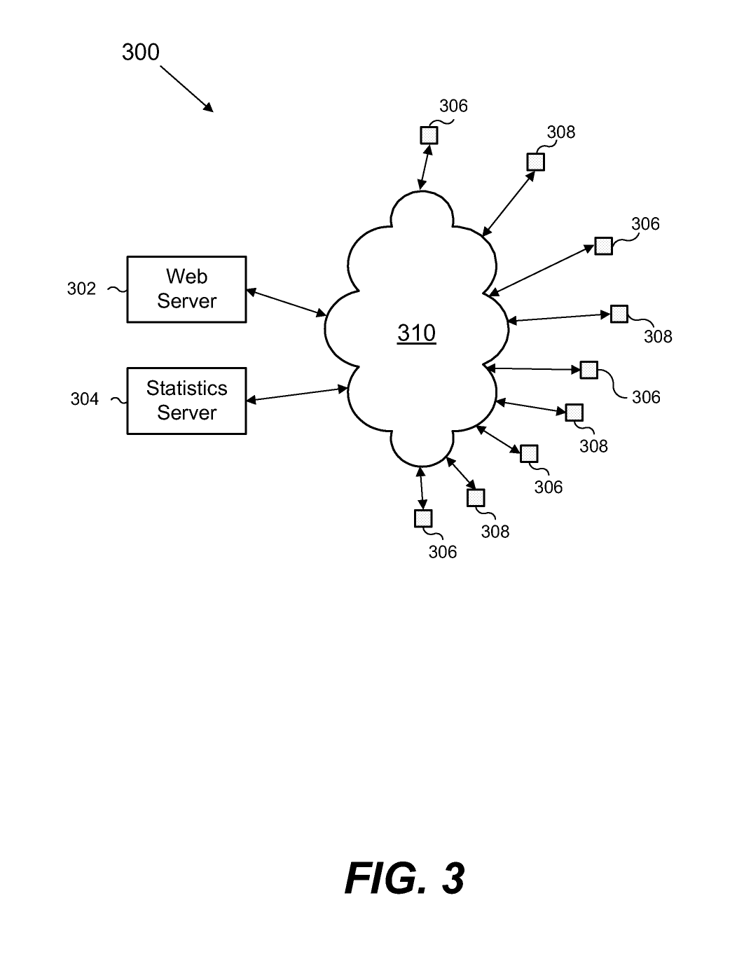

FIG. 3 is an illustrative drawing showing a system architecture 300 that includes a web server 302, a data collection server system 304 that performs data collection and analysis, second user devices 306 and third user devices 308 that are coupled to communicate over a network 310 such as the Internet. A first or second user device 306 or 308 may be a personal computer, laptop, notebook, personal digital assistant, network-attached storage, cellular phone, media center, set-top box, or other device or combination of devices, for example. The web server 302 serves the first web page 100 to the second user devices 306 and serves the second web page 200 to the third user devices 308. The first and second user devices 306, 308 communicate to the statistics server 304 information concerning the amount of time users spend viewing the respective first and second web pages 100, 200. The server 304 obtains a comparative time that is indicative of a difference between an amounts of time typically spent by first users viewing the first page 102 with the reference item 102 versus the time typically spent by second users viewing the second page 200 with the designated item 202.

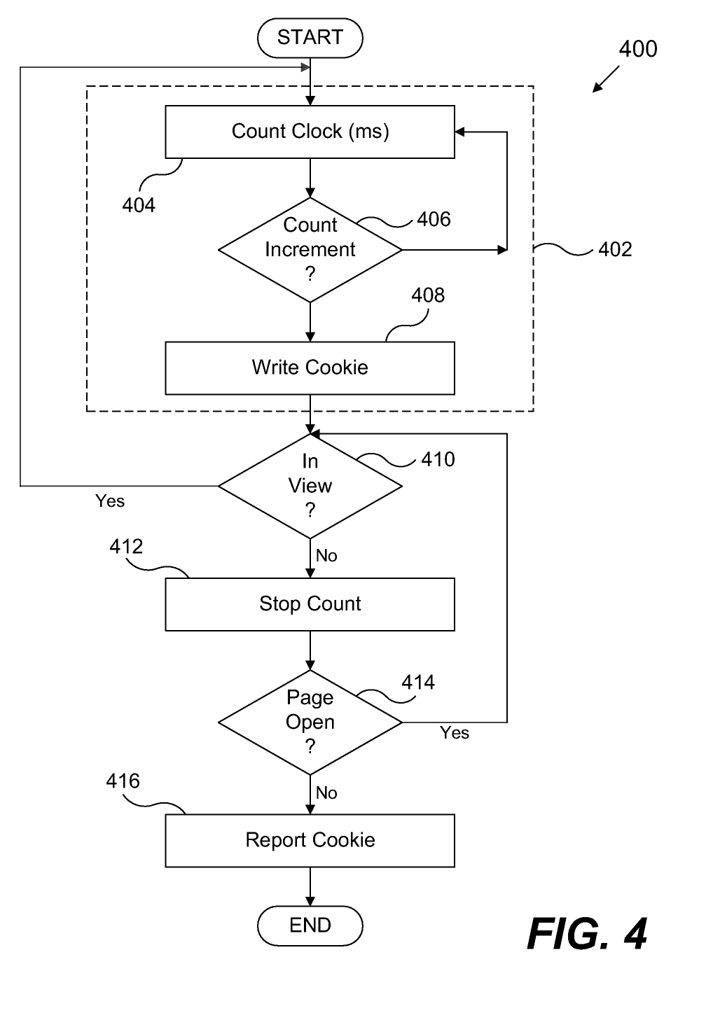

FIG. 4 is an illustrative flow chart of a first computer program controlled process 400 used to develop a comparative time measure that is indicative of the difference in the amount of time users spend viewing the first and second web pages 100, 200. The web server 302 serves the first computer program code together with the first and second web pages 100, 200 that causes the first and second user devices 306, 308 to track and report the time users spend viewing the web pages 100, 200. The statistics server 304 receives viewing time information reported by the user devices 304, 306 and calculates the comparative time measure based upon that received information.

The primary difference between the first and second web pages 100, 200 is the reference item 102 versus the designated item 202. Therefore, the comparative time measure is indicative of the difference in time typically spent by first users viewing the first page 100 with the reference item 102 and the time typically spent by second users viewing the second page 200 with the reference item 202. This time difference is indicative of the difference in user attentiveness to the reference item 102 and designated item 202.

The process of FIG. 4 starts when a user a user causes his or her device 306 or 308 to open a web page, either the first web page 100 or the second web page 200. The opening of a web page 100 or 200 ordinarily involves using a browser program to download the web page from the web server 302. A process represented within dashed lines 402 creates a record of the length of time during which the web page is in view. Specifically, program block 404 causes the user device 306 or 308 to count clock ticks as a time measure. Decision block 406 determines whether a 100 millisecond (“ms”) time increment has been measured. If not, then program block 404 causes the clock count to continue. If a 100 ms time interval has been counted, then block 408 causes the device to write (i.e. create) a cookie (i.e. a data storage structure) in a computer readable medium associated with the device to record the of the elapse of a 100 ms time interval. Thus, the cookie is updated periodically every 100 ms in some embodiments, provided that the web page is determined likely to be in view as explained below.

Decision block 410 determines whether the web page 100 or 200 is likely presently in view meaning whether the web page is displayed so that the user can look at it. In some embodiments, computer code including JavaScript is used to cause a user device to make the determination of decision block 410. In a JavaScript environment, a web page is not in focus if a ‘window’ used to display of the web page is minimized, grayed out or closed. In addition, in current JavaScript environments, only one ‘window’ is in focus at any given time. A typical web browser includes functionality that can detect whether a window displaying a web page is in focus. It will be appreciated, however, that it is sometimes possible for a user to look at a window that is not in focus, e.g. if two windows are side by side rather than one on top of the other. Unfortunately, current web browsers generally cannot detect that situation. Therefore, it will be understood that a determination by decision block 410 based upon whether the web page is in focus may be less than fully accurate since it may not be able to detect some scenarios in which a web page can be looked at by a user even though it is not in focus. However, the inventors believe that even with these shortcomings, measuring whether a web page is in view using the ‘in focus’ metric will lead to meaningful results. Moreover, the principles of the invention apply to other mechanisms or metrics to determine whether a user is likely to be able to look at the web page. Such other approaches may in fact improve accuracy of determinations of decision block 410.

If decision block 410 determines that the web page 100 or 200 is likely not in view, then program block 412 causes the device 306 or 308 to stop the time count. If the time count is stopped in step 412, then decision block 414 determines whether the web page is still open. A web page is no longer open (i.e. is closed) when a network link (i.e. a session) with the web server 302 is closed. A web page 100 or 200 may be closed as a result of a user command to close the page or as an result of an automatic time-out following the elapse of some prescribed amount of time during which there is no user activity involving the web page. Note that in a JavaScript environment, automated or manual time outs stop focus. If decision block 414 determines that the web page is still open, then decision block 410 again determines whether the web page is in view. If on the other hand, decision block 414 determines that the web page is closed, then program block 416 reports the timing information stored by the program block 408 to the server 304. Reporting to the server 304 involves sending a message over the network 310.

The process described above with reference to FIG. 4 runs on each of the first and second user devices 306, 308 to which a respective first or second web page 100, 200, is served. In some embodiments, the first web page 100 is served to a sufficient number of second user devices 306 to provide a reliable measure of the amount of time that a typical first user from a first plurality of users views the first web page 100. Similarly, the second web page 200 is served to a sufficient number of third user devices 308 to provide a reliable measure of the amount of time that a typical second user from a second plurality of users views the second web page 200.

The server 304 receives timing information reported by respective block 416 of the plurality of first and second user devices 306, 308. The server uses this information to compute a measure of the time that a typical first user is likely to spend looking at the first web page and the time that a typical second user is likely to spend looking at the second web page. The time measure may represent the average time, median time or other measure of central tendency indicative of the time a typical user typically spends looking at the web page delivered to such user. In arriving at a measure of the central tendency, the really long user viewing times and really short user viewing ort times may be excluded from the determination. For example, the top (longest) 20% user viewing times and bottom (shortest) 20% user times may be dropped, and the central tendency will be determined from the remaining middle 60%. This approach can be taken to eliminate aberrant cases in which a user just clicked past a web page, for example, resulting in a very short measure of user viewing time on the one hand, or a user left a page in view while leaving the room, for example, resulting in an unusually long measure of user viewing time. The server 304 uses these time measures to determine a comparative time measure that is indicative of a difference in the amount of time that respective first and second users typically spend looking at the respective first and second web pages.

The server 304 uses the comparative time and the baseline time to determine a measure of the amount of time that a typical user typically spends looking at the designated item 202. For example, assume that based upon eye tracking of the first plurality of users, the baseline time is determined to be 150 ms. Further, assume that based upon comparative results from the first users and the second users, the comparative time measure is determined to be 200 ms. In that case, a determination can be made that the typical amount of time spent by users in viewing the designated item is 350 ms=150 ms+200 ms. Thus, the baseline time and the comparative time measure together provide a measure of user attentiveness to the information item (e.g. an ad) in the context of a given web page.

The control loop involving blocks 410-414 ensures that the time measure recorded through the process 402 determines amounts of time during which the reference web page is both open and in view. It is assumed that when a web page is in view, the user may be viewing it, but when the web page is visible but not in view (e.g. blurred, grayed out, dimmed or minimized), the user probably is not viewing it. In some embodiments, the process 402 only counts as viewing time, the time during which the reference page is both open and in view.

Alternatively, however, a time during which the user has a reference web page open and viewable though not ‘in focus’ can be accounted for. For instance, as mentioned above in some browsers, a page that is open and displayed but not in focus may remain visible but in a blurred or grayed-out form or dimmed somewhat. Thus, it is possible that a user may spend some time viewing a page even though the page is not completely in focus. In that situation, in some embodiments, the time during which the reference page is open but not in focus may be counted at a scaled rate.

Conversely, in some browsers it is possible to have multiple windows opened and in focus simultaneously. In that case, the time during which a reference page is open and in focus can be scaled if there is at least one other window (e.g., to a web page or document or other information source) that is open and in focus at the same time. For example, if the reference page is open and in focus at the same time that one other window also is open and in focus, then the time during which the reference page is open may be discounted by 50 percent. Moreover, for example, if the reference page is open and in focus at the same time that two other windows also are open and in focus, then the time during which the reference page is open may be discounted by 66 percent. Other scaling factors are possible such as scaling based upon screen area. For example, if an in focus reference web page occupies 75 percent of a display screen and another in focus window occupies the remainder then, the time during which the reference page is open may be discounted by 25 percent.

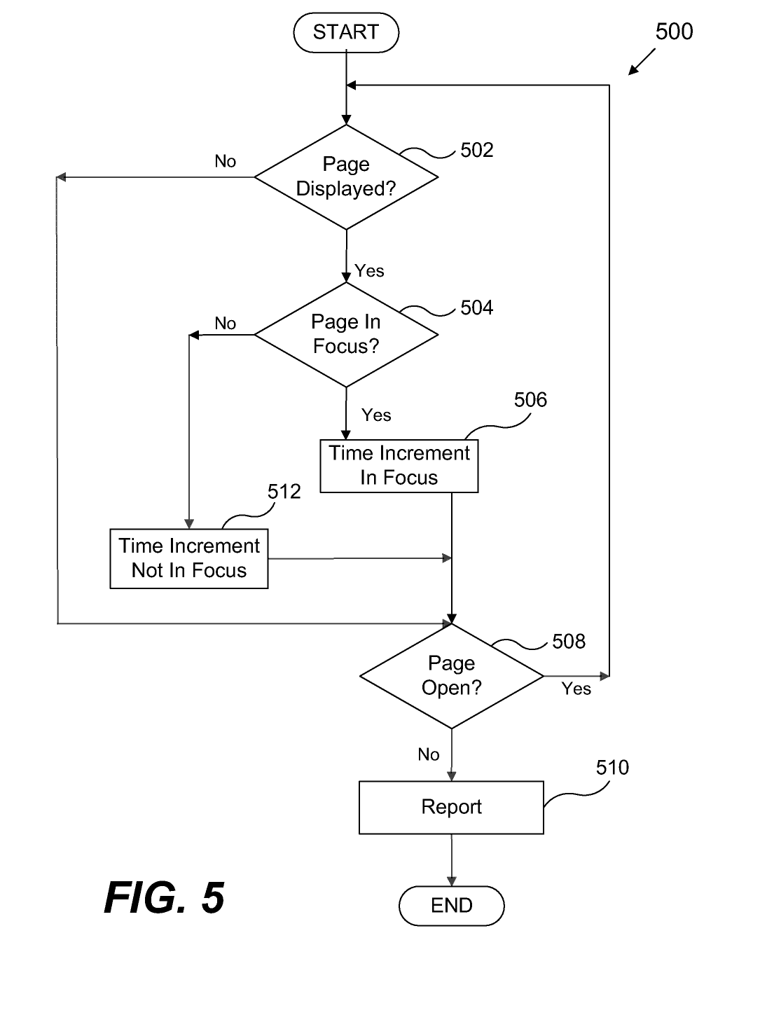

FIG. 5 is an illustrative flow chart of an alternative second computer program controlled process 500 to develop a comparative time measure that is indicative of differences in the amount of time users typically spend viewing the first and second web pages and that accounts for time when the web pages are in view but possibly not the main focus of user attention. As with the first process 400 explained with reference to FIG. 4, the web server 302 serves the second computer program code together with the first and second web pages 100, 200 that causes the user devices 306, 308 to track and report the time users spend viewing the web pages 100, 200. The statistics server 304 receives viewing time information reported by the user devices 304, 306 and calculates the comparative time measure based upon that received information. In the case of the second process, however, the comparative time measure takes into account time during which users are likely to pay less than their full attention to the subject web page, i.e. either the first or second web page 100, 200, as the case may be.

The process of FIG. 5 starts when a user a user causes his or her device 306 or 308 to open a web page, either the first web page 100 or the second web page 200. In decision block 502, a determination is made as to whether the subject web page, either the first or second web page 100, 200, is displayed or is minimized or otherwise hidden from view. If decision block 502 determines that the subject page is hidden from view, then control flows to decision block 508, which is discussed below. If on the other hand, decision block 502 determines that the subject page is not displayed, then control flows to decision block 504. In decision block 504, a determination is made as to whether the subject web page, either the first or second web page 100, 200, is in focus. This determination involves a determining whether the display of the subject web page indicates that it is not the primary focus of the user's attention. For example, the determination may involve determining whether the display of the subject web page is visible even though it may be blurred or grayed-out or dimmed.

It will be understood that the decision block 410 of FIG. 4 combines determinations of whether the subject page is displayed and in focus. Whereas, decision blocks 502 and 504 of the process of FIG. 5 make separate determinations as to whether the subject page is displayed and in focus, respectively. The separate determinations allow for scaling of the time interval during which the subject page is in some manner only partially displayed such as by blurring, graying out or dimming, for example.

If decision block 504 determines that the subject web page is in focus, then a first time recording process program module 506 records a prescribed time increment such as 100 ms, for example, during which the subject web page is open, displayed and in focus. A first time increment recording process can be identical to that shown within dashed lines 402 in FIG. 4. Decision block 508 then determines whether the subject web page still is open. If decision block 508 determines that the subject page no longer open, then program block 510 reports the timing information recorded by program block 506 and any timing information previously recorded by program block 510, discussed below, to the statistics server 304.

If on the other hand, decision block 508 determines that the subject page still is open, then control flows to decision block 502, which again determines whether the subject page is displayed. If decision block 502 determines that the subject web page is displayed, then control again flows to decision block 504 as described above. However, if decision block 502 determines that the subject web page is in not displayed, then control flows to decision block 508, which determines whether the subject page is still open as described above.

If the decision block 504 determines that the subject web page is not in focus, then control passes to a second time recording process controlled by program block 512. The flow of the timing process of block 512 can be analogous to that of process 402 of FIG. 4. The second time recording process runs a second clock count to keep track of time when the subject page is displayed but not in focus. The second time recording process records the occurrence of a prescribed time increment such as 100 ms, for example, during which the subject web page is open and in focus. In some embodiments, the displayed but out-of-focus time interval is recorded using a second cookie. Control then passes to decision block 508, which determines whether the subject web page still is open.

Assume, for example, that the process of FIG. 5 is performed on a plurality of first user devices 306 that display the first web page 100 and on a plurality of second web pages 200 that display the second web page 200. Further, assume that the statistics server 304 a typical first user views the first web page 100 displayed in focus for 20,000 ms and views the first page not in focus for 5,000 ms. Further, assume that the scaled rate for accounting for time when the page is out of focus is 10 percent. In that case, the duration of time during which the first page would be determined to have been viewed by the typical first user would be 20,500=20,000+(0.10)(5,000). The statistics server 304 makes a similar calculation that encompasses times during which a typical user views the second web page 200 in focus time and not in focus, with a scaling factor applied to the out of focus time. A comparative time measure is determined based upon the difference between the time value determined for the typical viewer of the first page 100 and the time value determined for the typical viewer of the second page 100. The comparative time measure is combined with the baseline time as described above to determine a measure of user attentiveness.

It will be appreciated that user attentiveness information can be used, for example, to achieve better ad pricing or to improve ad campaign effectiveness. For instance, an advertiser may be willing to pay an amount per impression that is based upon the amount of time that a typical user is determined to be likely spend looking at an ad in the context of on a web page. The attentiveness information can improve an ad campaign through testing of user attentiveness to different ads and to different ad combinations and by selecting the ads and combinations that garner optimal attentiveness.

In a first alternative embodiment, the baseline time is determined based upon the size of the portion of a reference web page (not shown) occupied by a reference information item. In this first alternative, it is assumed that the proportion of the reference page occupied by the reference item is indicative of the proportion of time that an individual spends viewing the reference information item. In order to determine a baseline viewing time for the reference item, a plurality of individuals view the reference web page that includes the reference item. Based upon the relative portion of the web page occupied by the reference item, a determination is made as to the amount of time that the plurality of individuals typically spend looking at the reference page. For example, if it is assumed that the time that a person spends viewing the reference item is directly proportional to the proportion of the total page occupied by the reference item, then if the reference item occupies 10 percent of the reference page, for instance, it may be determined that 10 percent of the time that the baseline-test individuals typically spend looking at the reference page is spent viewing the reference item. It will be appreciated that different relationships between the relative portion of the page area occupied by a reference item and time spent looking at the reference item on the page can be used consistent with the invention to obtain a baseline measure of user attentiveness to the reference item. For example, the relative attention attributed to the reference item based upon area that it occupies may be weighted more heavily for a reference item appearing nearer the beginning (top) of the page than for a reference item appearing near the middle or end of the page.

In the first alternative embodiment a comparative time measure is obtained in the manner described above. For example, assume that a determination is made during baseline measurements that a typical individual views the reference page for 5,000 ms, and that the reference item occupies 10 percent of the page. In accordance with the first embodiment, a determination could be made that a typical individuals spend approximately 500 ms viewing the reference item. Further, assume that a user from the first plurality of users typically views the same reference web page but with the designated item substituted for the reference item, for 300 ms longer than a user from the second plurality typically view the reference web page with the reference item. Thus, the comparative time measure is 300 ms. In that case, in accordance with the first alternative embodiment, a determination can be made that the typical time spent by users in viewing the new designated item is 800 ms=500 ms+300 ms.

A second alternative embodiment measures the impact upon user attentiveness of color contrast between an item on a web page (e.g. an advertisement) and other portions of the web page. The second alternative assesses the relationship between color contrast between a reference item and other portions of a web page and the amount of time that a user spends viewing the reference item on the web page. In other words, the second alternative embodiment evaluates the degree to which color contrast between a reference item and other portions of a reference web page influence user attentiveness to the reference item. Noisy pages in terms of color content, often garner less user attention because the pages themselves can be more confusing to users. Thus, the second alternative embodiment seeks to ascertain the degree to which color contrast between an item, such as an ad, and other portions of the page transcends color-noisiness and results in the item garnering relatively more user attention.

Referring again to FIG. 1, in the second alternative embodiment, a reference measure of color contrast between the reference item 102 and the rest of the first web page 100 is obtained. A baseline time is determined that is indicative of the amount of time spent by individuals looking at the reference item 102 on the first web page 100. The determination may involve eye tracking. In the second alternative embodiment, the determined baseline time corresponds to a reference color contrast value, i.e. the color contrast between reference item 102 and other portions of the first web page 100.

In some embodiments, obtaining a reference color contrast involves use of a color map for reference web page, such as the first web page 100. For instance, a color map can be constructed using RGB (red, green, blue) colors, each measured on a conventional 0 to 255 scale. A color map of a first web page 100 provides a measure of the overall ‘noisiness’ of the page. In addition, a color map is made of the reference item 102 on the page 100. A determination is made of color contrast between the reference information item 102 and the color map for the rest of the page 100. Alternatively, a determination can be made of color contrast between the reference information item 102 and the color map for the entire page 100.

In some embodiments, the color contrast is represented in terms of (xₜ,yₜ,zₜ), which refer to the RGB colors at pixel t. The page mean is,

$$( \overline{x} , \overline{y} , \overline{z} ) = ( \frac{1}{T} {\sum }_{t} {x}_{t} , \frac{1}{T} {\sum }_{t} {y}_{t} , \frac{1}{T} {\sum }_{t} {z}_{t} )$$

where there are T pixels on the page and the sums are taken over the page. The page standard deviation is,

$$\sqrt{\frac{1}{T - 1} {\sum }_{t} {( {x}_{t} - \overline{x} )}^{2} + {( {y}_{t} - \overline{y} )}^{2} + {\sum }_{t} {( {z}_{t} - \overline{z} )}^{2}}$$

A relevant measure, if there are A pixels in an advertisement, is the ratio of the standard deviation of the pixels on the reference item (e.g. an ad) versus those on the page using the page mean in both cases, or

$$\frac{\sqrt{\frac{1}{A - 1} {\sum }_{t in ad} {( {x}_{t} - \overline{x} )}^{2} + {( {y}_{t} - \overline{y} )}^{2} + {\sum }_{t} {( {z}_{t} - \overline{z} )}^{2}}}{\sqrt{\frac{1}{T - 1} {\sum }_{t on page} {( {x}_{t} - \overline{x} )}^{2} + {( {y}_{t} - \overline{y} )}^{2} + {\sum }_{t} {( {z}_{t} - \overline{z} )}^{2}}}$$

Note that because red, green and blue have different intensities, it is often useful to use color weights R, G, B:

$$\frac{\sqrt{\frac{1}{A - 1} {\sum }_{t in ad} {R ( {x}_{t} - \overline{x} )}^{2} + {G ( {y}_{t} - \overline{y} )}^{2} + {\sum }_{t} {B ( {z}_{t} - \overline{z} )}^{2}}}{\sqrt{\frac{1}{T - 1} {\sum }_{t on page} {R ( {x}_{t} - \overline{x} )}^{2} + {G ( {y}_{t} - \overline{y} )}^{2} + {\sum }_{t} {B ( {z}_{t} - \overline{z} )}^{2}}}$$

to improve the metric.

In the second alternative embodiment, a baseline relationship between time spent looking at an information item and color contrast is established for generic pages. For example, a set of individuals might be shown a reference web page that is red and white except for a blue reference item. Assume that a determined that the blue reference item typically garners 5% of these individuals' viewing time. This baseline time measure could be established, for example, either by running information items on test pages or using eye-tracking software. As a result of this determination, when the first web page is displayed attribute 5% of the viewing time is attributed to the blue information item.

Referring again to FIG. 2, assume for example, that that a determination is to be made as to the amount of time that a typical user spends viewing a designated item on a second web page 200 in which the designated item 202 is green (rather than blue). in this example, except for the color difference between the reference item 102 (blue) and the designated reference item 202 (green), the second web page 200 is substantially the same as the first web page 100. Referring again to FIG. 3, the web server 302 sends the first web page 100 (the reference web page) with the item 102 in blue to a plurality of first user devices 306. The web server 302 sends the second web page 200 with the same item 202 except in green to a plurality of second user devices 308.

Using the process described with reference to FIG. 4, the first and second devices 306, 308 collect and report to server 304 the amount of time respective first and second users spend viewing the first and second web pages 100 and 200, respectively. Assume, for example, that the server 304 determines that a typical first user typically spends 3 minutes viewing the first web page 100 with the item 102 in blue. Then, based upon the baseline time determination, by allocating 5% of those 3 minutes to viewing of the blue information item 102, the server 304 determines that a typical first user views the blue (first) reference item 102 for 9 seconds. Further assume that the server 304 determines that a typical second user typically spends 3 minutes and 12 seconds viewing the second web page 200 with the information item 202 in green. The comparative difference between the time first users view the first web page 102 and the time second users view the second web page is 12 seconds (192 seconds−180 seconds). Using the baseline time factor of 5%, the time that first users spend viewing the reference item 102 is determined to be 9 seconds (0.05×180 seconds). Therefore, the amount of time spent by second users viewing the information item 202 (green color) is determined to be 21 seconds (12 seconds+9 seconds).

In the second alternative embodiment, differences in user attentiveness to the reference item 102 and a designated item 202 are indicative of the impact of color contrast upon user attentiveness. The example mathematical color contract metrics set forth above provide a quantitative approach to distinguishing among different color contrast measures. Such mathematical characterization of color contrast is helpful, for example, to define color contrast where an ad and the rest of the page each is comprised of multiple colors. In other words, for example, an ad typically is not just green or blue but may comprise multiple colors for text and images, for instance.

The second alternative embodiment also can be used to assess the impact upon user attentiveness of animation associated with an item on a web page. An information item may have animated graphics or a video, for example. Animation influences user attention. However, too much animation actually can be confusing and distracting rather than attention grabbing. The approach described above for the second alternative embodiment is applicable where the difference between the reference item 102 and a designated item 202 is the degree of animation rather than the degree of color contrast.

Similarly, the second alternative embodiment can be used to assess the impact upon user attentiveness of sound. Sound can be associated with an information item on a web page. The approach described above for the second alternative embodiment is applicable where the difference between the reference item 102 and a designated item 202 is the difference in sounds associated with each rather than the degree of color contrast.

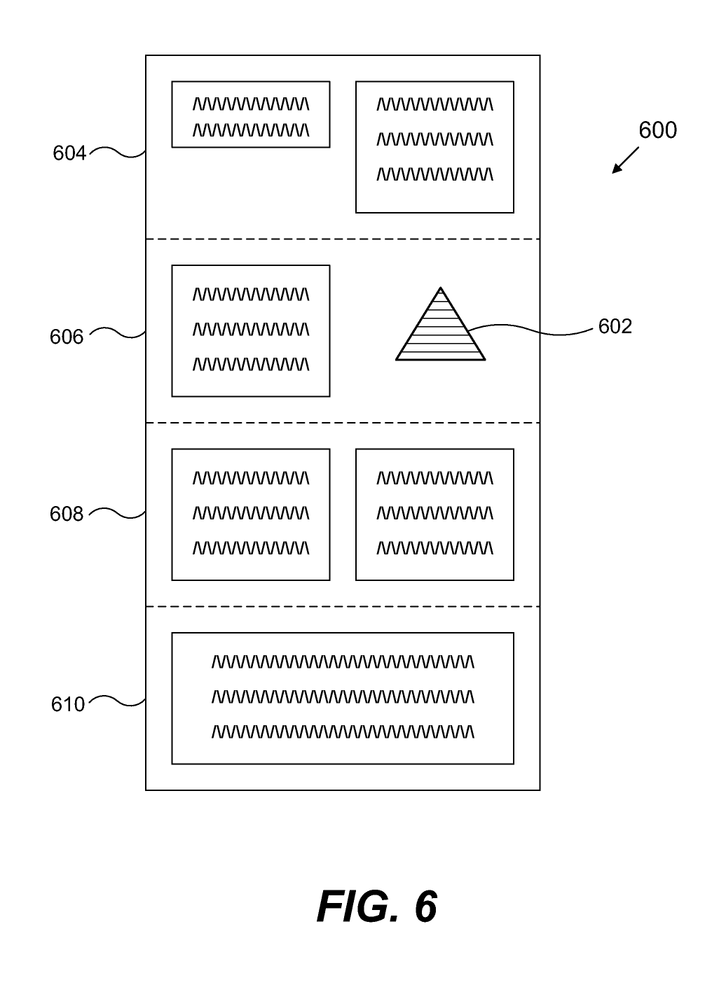

FIG. 6 is an illustrative drawing of a multi-screen web page 600. Often, a web page is too large to be presented all at once on a user computer display screen. A browser typically provides a viewing window through which a web page can be viewed. The web page 600 includes a subject information item 602 that may be either a reference item or a designated item depending upon whether it is served to first or second devices 304, 306. The example web page 400 includes segments 604-610 each of which occupies an entire browser viewing window. Viewing window size may vary between different browsers. In some browsers viewing window size is a user selectable option. Most browsers include scroll bars to permit user to navigate through a web page displayed in the browser window. The portion of the page visible in the browser window changes as the user actuates the scroll bar. If the reference page is too large to view on the browser window all at once, then it is possible that the designated item or reference item will be visible to the user for only a portion of the time during which the page is open. The example web page 400 includes four segments 604-610 each of which occupies an entire browser viewing window. The subject information item 602 is included in only one segment 604 and is viewable only during the time that segment is displayed in the browser viewing window. Therefore, in some embodiments, the time during which a reference page is open is scaled if the new item or reference item is visible for only a part of the time during which the reference page is open.

For example, in some embodiments, different baseline time increments are accorded to different parts of the same web page. The increments can be determined through eye tracking of the individuals involved with determining the baseline time. Alternatively, the increments could be determined through clever coding. For example, when a user hovers a mouse device over a link, a cookie write could be prompted so as to store an indication of what portion of the page the user is viewing. Specifically, for example, JavaScript includes a hover command that can be used to update a cookie (a data storage structure in computer memory) to indicate the segment of a page that a user is viewing during a particular time increment. For example, in a survey of users it might be determined that 90% of users read the first displayed segment of a page, 80% read the second displayed segment, 60% read the third displayed segment and 20% read the rest. In that case, the typical viewing time could be allocated accordingly. In other words, for example, if an item (e.g. an ad) is displayed on the third segment of the web page, then the viewing time accorded to the item is scaled by 60% of the determined viewing time for the item.

A computer system can be programmed to display a subject web page and to run the first and second program controlled processes in accordance with embodiments of the invention. A computer system can include one or more processors. A processor can be implemented using a general or special purpose processing engine such as, for example, a microprocessor, controller or other control logic. For example, a processor may be connected to a bus or other communication medium.

A computing system can include a main memory, preferably random access memory (RAM) or other dynamic memory, for storing information and instructions to be executed by a processor. Main memory also may be used for storing temporary variables or other intermediate information during execution of instructions to be executed by the processor. The computer system can likewise include a read only memory (“ROM”) or other static storage device coupled to a bus for storing static information and instructions for the processor. The main memory and the storage devices may store data such as cookies that record user viewing time for a subject page that is in focus or out of focus, for example. The main memory and the storage devices may store instructions such as instructions to develop a substrate model that includes observation ports and that receives substrate model information. The main memory and the storage devices also may store instructions to simulate the propagation of substrate noise from digital block noise sources to substrate noise sensitive analog blocks.

The computer system can also include an information storage mechanism, which can include, for example, a media drive and a removable storage interface. The media drive can include a drive or other mechanism to support fixed or removable storage media. For example, a hard disk drive, a floppy disk drive, a magnetic tape drive, an optical disk drive, a CD or DVD drive (R or RW), or other removable or fixed media drive. Storage media can include, for example, a hard disk, a floppy disk, magnetic tape, optical disk, a CD or DVD, or other fixed or removable medium that is read by and written to by the media drive. The information storage mechanism also may include a removable storage unit in communication with the removable storage interface. Examples of such removable storage unit can include a program cartridge and cartridge interface, a removable memory (for example, a flash memory or other removable memory module). As these examples illustrate, the storage media can include a computer useable storage medium having stored therein particular computer software or data.

The computer system also includes a display unit that can be used to display a subject web page, for example. The computer system also includes a network connection (not shown).

In this document, the terms “computer program medium” and “computer useable medium” are used to generally refer to media such as, for example, memory, a storage device, or a hard disk installed in hard disk drive. These and other various forms of computer useable media may be involved in carrying one or more sequences of one or more instructions to the processor for execution. Such instructions, generally referred to as “computer program code” (which may be grouped in the form of computer programs or other groupings), when executed, enable the computing system to perform features or functions of the present invention as discussed herein.

The foregoing description and drawings of preferred embodiments in accordance with the present invention are merely illustrative of the principles of the invention. Various modifications can be made to the embodiments by those skilled in the art without departing from the spirit and scope of the invention, which is defined in the appended claims.

1. A method to determine user attentiveness to an information item included in a web page comprising:
obtaining a baseline time that represents a typical amount of time that respective first individuals look at the first information item included in the first web page image;
sending a first web page over a network to a plurality of first user devices;
sending a second web page over the network to a plurality of second user devices;
wherein the second web page appears substantially the same as the first web page except that the second web page includes a second information item instead of the first information item;
obtaining respective first time measurements that are indicative of an amount of time that respective first users of the first user devices typically spend looking at the first web page;
obtaining respective second time measurements that are indicative of an amount of time that respective second users of the second user devices typically spend looking at the second web page;
using the respective first and second time measurements to determine a comparative time measure that is indicative of a difference in amounts of time respective first and second users typically spend looking at the respective first and second web pages;
using the baseline time and the comparative time measure to determine an amount of time that a typical user is likely to spend looking at the second information item included in the second web page.

2. The method of claim 1 wherein
displaying an image representing a first web page that includes a first information item to a first plurality of first individuals;
tracking eye movements of respective first users to measure the amount of time such first users spend looking at the first information item included in the first web page image.

3. The method of claim 1 wherein obtaining a baseline time includes:
determining respective amounts of time first users typically spend looking at the image of the first web page; and
determining a proportion of the first web page occupied by the first information item.

4. The method of claim 1 wherein,
the first time measurements are indicative of an amount of time that the respective first users of the first user devices typically had the first web page open and in view; and
the second time measurements are indicative of an amount of time that the respective second users of the second user devices typically had the second web page open and in view.

5. The method of claim 1 wherein,
the first time measurements are indicative of an amount of time that the respective first users of the first user devices typically had the first web page is in focus; and
the second time measurements are indicative of an amount of time that the respective second users typically had the second web page in focus.

6. The method of claim 1 wherein,
using the baseline time and the comparative time measure to determine an amount of time that a typical user is likely to spend looking at the second information item included in the second web page includes summing the baseline time and the comparative time measure.

7. The method of claim 1,
wherein a color contrast associated with the first information item on the first web page is different from color contrast associated with the second information item on the second web page.

8. The method of claim 1,
wherein degree of animation associated with the first information item on the first web page is different from degree of animation associated with the second information item on the second web page.

9. The method of claim 1,
wherein obtaining respective first time measurements includes receiving the first measurements over the network; and
wherein obtaining respective second time measurements includes receiving the second measurements over the network.

10. The method of claim 1 further including;
using location of the second information item to estimate an amount of time that a typical user is likely to spend looking at the second information item included in a second web page that includes multiple segments.

11. A method to determine user attentiveness to an information item included in a web page comprising:
obtaining a baseline time that represents a typical amount of time that respective first individuals look at the first information item included in the first web page image;
sending a first web page over a network to a plurality of first user devices;
sending a second web page over the network to a plurality of second user devices;
wherein the first web page includes a first information item and the second web page include a second information item and a sound associated with the first information item is different from a sound associated with the second information item;
obtaining respective first time measurements that are indicative of an amount of time that respective first users of the first user devices typically spend looking at the first web page;
obtaining respective second time measurements that are indicative of an amount of time that respective second users of the second user devices typically spend looking at the second web page;
using the respective first and second time measurements to determine a comparative time measure that is indicative of a difference in amounts of time respective first and second users typically spend looking at the respective first and second web pages; and
using the baseline time and the comparative time measure to determine an amount of time that a typical user is likely to spend looking at the second information item included in the second web page.
